(19) United States
(12) Patent Application Publication
(10) Pub. No.: US 2021/0339507 A1
(43) Pub. Date: Nov. 4, 2021

(54) CRACK-RESISTANT COMPOSITE WOOD CONSTRUCTION

(71) Applicant: Min-Ju Chung, Taichung City (TW)

(72) Inventor: Min-Ju Chung, Taichung City (TW)

(21) Appl. No.: 16/864,941

(22) Filed: May 1, 2020

(51) Int. Cl. B32B 21/13; B32B 3/30

(52) U.S. Cl. CPC B32B 21/13; B32B 2419/04; B32B 3/30

(57) ABSTRACT

A crack-resistant composite wood construction includes a first wooden body and a second wooden body. The first wooden body has a natural wood grain in a first wood grain direction, and includes a first juncture surface, and at least a first crack-resistant groove which is formed in the first juncture surface and which is elongated in the first wood grain direction. The second wooden body has a natural wood grain in a second wood grain direction, and includes a second juncture surface which is adhered to the first juncture surface, and at least a second crack-resistant groove which is formed in the second juncture surface and which is elongated in the second wood grain direction.

### FIELD

The disclosure relates to a wood construction, more particularly to a crack-resistant composite wood construction.

### BACKGROUND

Wood composite board is a very commonly used wood construction which may be mounted on the ground or a wall and which is advantageous in having a light weight and an affordable price. In addition to the above, the wood composite board may have a wood grain texture which provides an aesthetic benefit.

To prevent delamination of the wood composite board due to thermal expansion, the wood composite board may have wood pieces which are cut from logs, and which are adhered to each other with their wood grain directions consistent with each other.

However, a period of time after use, the wood composite board may crack in the wood grain directions. This is because the wood fibers in a log extend along its wood grain direction. As such, the wood composite board may have a relatively high rigidity in the wood grain direction, and a relatively low rigidity in a width direction transverse to the wood grain direction. If the wood composite board disposed outdoors is exposed to sunlight and rain, the wood fibers repeatedly expand and contract, causing separation of the wood fibers in the width direction. This may result in deformation of the wood composite board or cracking of the wood composite board in the wood grain direction.

### SUMMARY

Therefore, an object of the disclosure is to provide a crack-resistant composite wood construction which is more durable than the conventional wood composite board.

According to the disclosure, a crack-resistant composite wood construction includes a first wooden body and a second wooden body. The first wooden body has a natural wood grain in a first wood grain direction, and includes a first juncture surface, and at least a first crack-resistant groove which is formed in the first juncture surface and which is elongated in the first wood grain direction. The second wooden body has a natural wood grain in a second wood grain direction, and includes a second juncture surface which is adhered to the first juncture surface, and at least a second crack-resistant groove which is formed in the second juncture surface and which is elongated in the second wood grain direction.

With the provision of the first and second crack-resistant grooves respectively in the first and second wooden bodies, the first and second wooden bodies are less likely to have stresses accumulated therein, and thus are less likely to deform or to crack. Hence, the crack-resistant composite wood construction may be more durable than a conventional one.

### BRIEF DESCRIPTION OF THE DRAWINGS

Other features and advantages of the disclosure will become apparent in the following detailed description of the embodiment(s) with reference to the accompanying drawings, in which:

FIG. 1 is a perspective view of a crack-resistant composite wood construction according to a first embodiment of the disclosure;

FIG. 2 is a partially exploded perspective view of the first embodiment;

FIG. 3 is a right side view of the first embodiment;

FIG. 4 is a bottom view of a first wooden body of the first embodiment;

FIG. 5 is a top view of a second wooden body of the first embodiment;

FIG. 6 is a right side view of a crack-resistant composite wood construction according to a second embodiment of the disclosure;

FIG. 7 is a bottom view of a first wooden body of the second embodiment;

FIG. 8 is a top view of a second wooden body of the second embodiment;

FIG. 9 is a right side view of a crack-resistant composite wood construction according to a third embodiment of the disclosure;

FIG. 10 is a bottom view of a first wooden body of the third embodiment; and

FIG. 11 is a top view of a second wooden body of the third embodiment.

### DETAILED DESCRIPTION

Before the disclosure is described in greater detail, it should be noted that where considered appropriate, reference numerals have been repeated among the figures to indicate corresponding or analogous elements, which may optionally have similar characteristics.

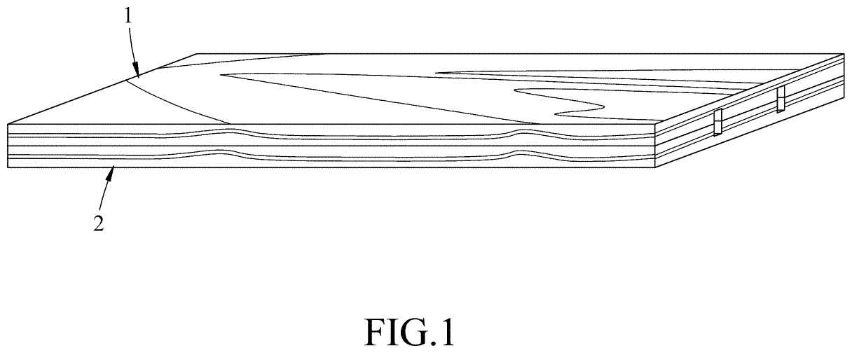

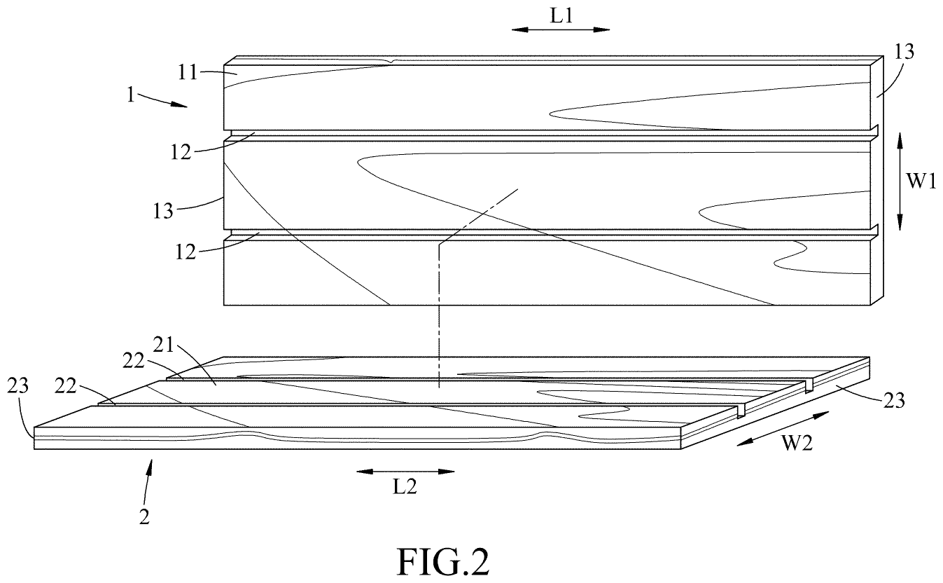

Referring to FIGS. 1 and 2, a crack-resistant composite wood construction according to a first embodiment of the disclosure is shown to include a first wooden body 1 and a second wooden body 2.

As shown in FIGS. 2 to 4, the first wooden body 1 has a natural wood grain in a first wood grain direction (L1), and includes a first juncture surface 11, and a pair of first crack-resistant grooves 12 each of which is formed in the first juncture surface 11 and each of which is elongated in the first wood grain direction (L1). In other embodiments, the first wooden body 1 may include one, three or more of the first crack-resistant grooves 12 based on requirement.

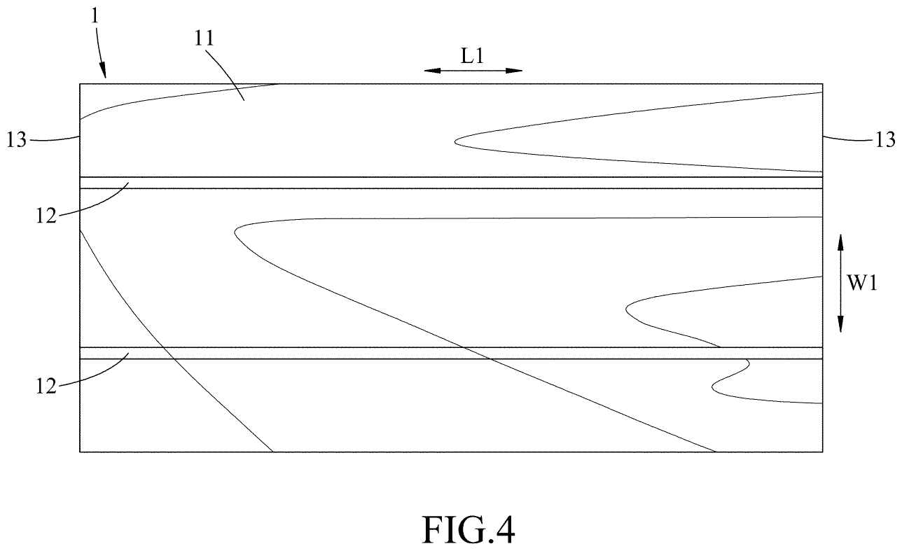

In an embodiment shown in FIG. 4, the first wooden body 1 includes a pair of first marginal ends 13 which are opposite to each other in the first wood grain direction (L1). Each of the first crack-resistant grooves 12 extends in the first wood grain direction (L1) from one of the first marginal ends 13 to the other one of the first marginal ends 13.

As shown in FIGS. 2, 3, and 5, the second wooden body 2 has a natural wood grain in a second wood grain direction (L2), and includes a second juncture surface 21 which is adhered to the first juncture surface 11, and a pair of second crack-resistant grooves 22 each of which is formed in the second juncture surface 21 and each of which is elongated in the second wood grain direction (L2). In other embodiments, the second wooden body 2 may include one, three or more of the second crack-resistant grooves 22 based on requirement.

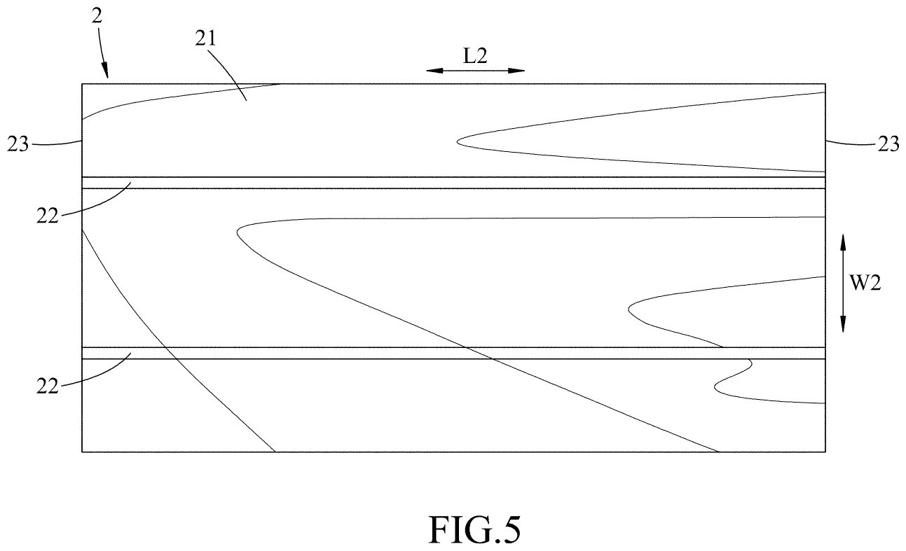

In an embodiment shown in FIG. 5, the second wooden body 2 includes a pair of second marginal ends 23 which are opposite to each other in the second wood grain direction (L2). Each of the second crack-resistant grooves 22 extends in the second wood grain direction (L2) from one of the second marginal ends 23 to the other one of the second marginal ends 23.

In an embodiment shown in FIGS. 1 to 5, the first and second wooden bodies 1, 2 are both in plank forms, and both have rectangular shapes of the same dimension in a plane view. In other embodiments, the first and second wooden bodies 1, 2 may be in forms other than the plank forms, such as a block, a strip, or any other form based on requirements.

In an embodiment shown in FIGS. 1 and 2, the first and second wood grain directions (L1, L2) are substantially the same to prevent delamination of the crack-resistant composite wood construction due to thermal expansion. In other embodiments, the first and second wood grain directions (L1, L2) may be transverse to each other.

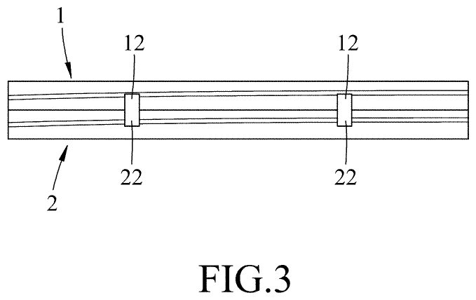

In an embodiment shown in FIGS. 2 and 3, the first and second crack-resistant grooves 12, 22 may, but are not limited to, be in register with each other.

In an embodiment shown in FIGS. 2 to 5, the first crack-resistant grooves 12 are spaced apart from each other and evenly distributed in the first juncture surface 11 in a first width direction (W1) of the first wooden body 1, and the second crack-resistant grooves are spaced apart from each other and evenly distributed in the second juncture surface 21 in a second width direction (W2) of the second wooden body 2. Due to this configuration, stress may be evenly distributed in the first and second wooden bodies 1, 2 and the crack-resistant composite wood construction is less likely to become damaged.

Specifically, when the crack-resistant composite wood construction is exposed to outdoor climate conditions (such as sunlight, rain, etc.) to repeatedly expand and contract, fibers in the first and second wooden bodies 1, 2 have the sufficient space in the first width direction (W1) or the second width direction (W2) so that expansion and contraction of the first and second wooden bodies 1, 2 is permitted. As such, stress is not accumulated in the first and second wooden bodies 1, 2 to cause deformation or cracking of the first and second wooden bodies 1, 2. Therefore, the crack-resistant composite wood construction may be more durable than a conventional one.

Furthermore, because the first and second crack-resistant grooves 12, 22 are respectively formed in the first and second juncture surfaces 11, 21, the provision of the first and second crack-resistant grooves 12, 22 do not affect the outer appearance of the crack-resistant composite wood construction.

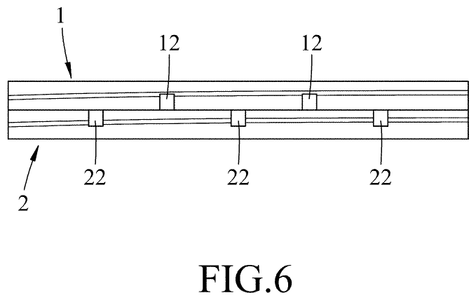

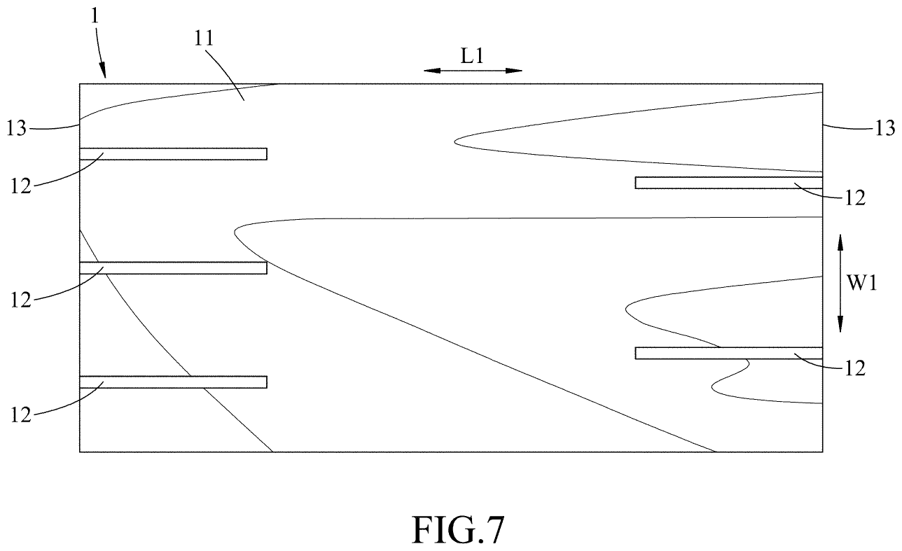

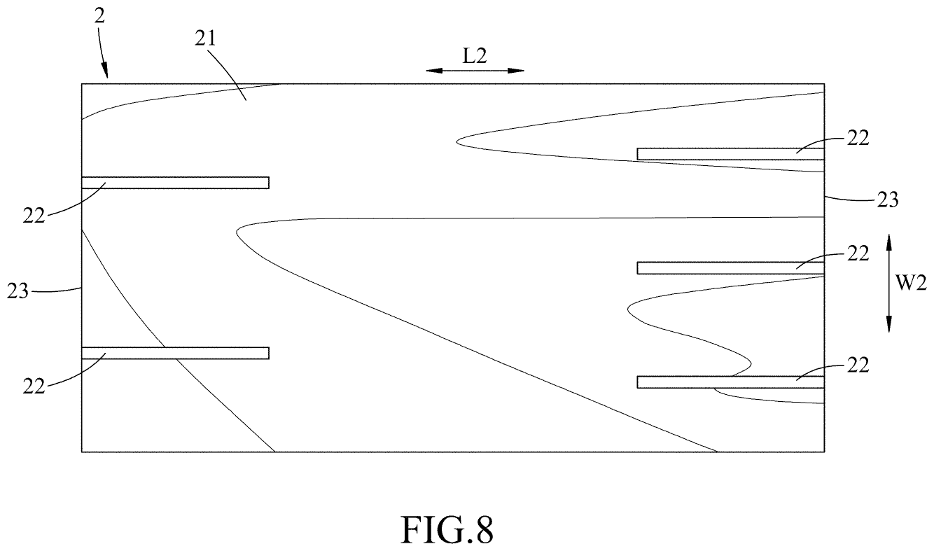

FIGS. 6 to 8 illustrate a crack-resistant composite wood construction according to a second embodiment of the disclosure. The second embodiment is similar to the first embodiment, except that in the second embodiment, each of the first crack-resistant grooves 12 extends in the first wood grain direction (L1) from one of the first marginal ends 13 without reaching the other one of the first marginal ends 13, and each of the second crack-resistant grooves 22 extends in the second wood grain direction (L2) from one of the second marginal ends 23 without reaching the other one of the second marginal ends 23. In addition, the first and second crack-resistant grooves 12, 22 may be staggered from each other.

The second embodiment may also achieve the effects achieved in the first embodiment, and exemplifies that the number and position of the first crack-resistant grooves 12 and the second crack-resistant grooves 22 may be freely varied based on requirements.

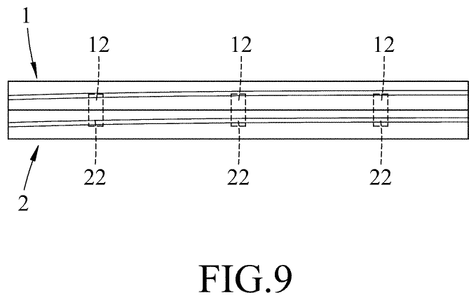

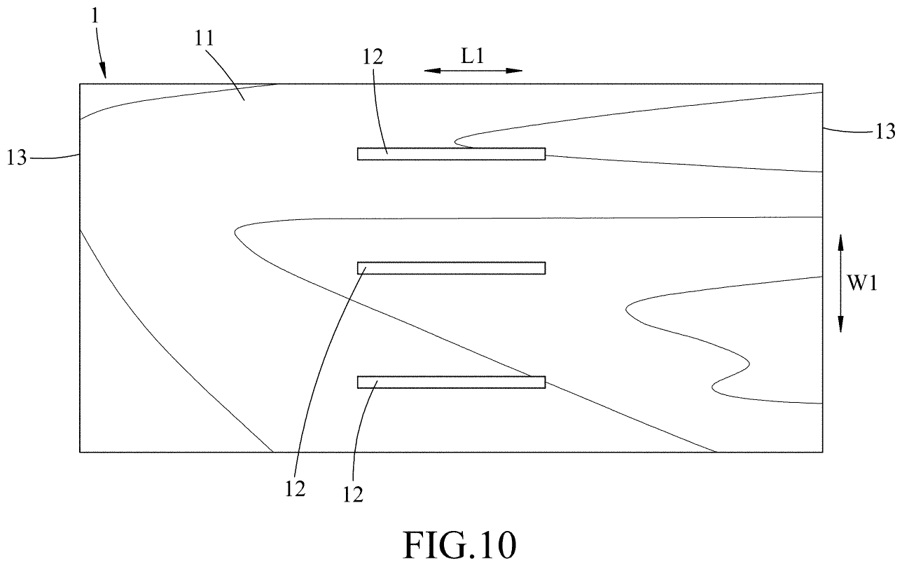

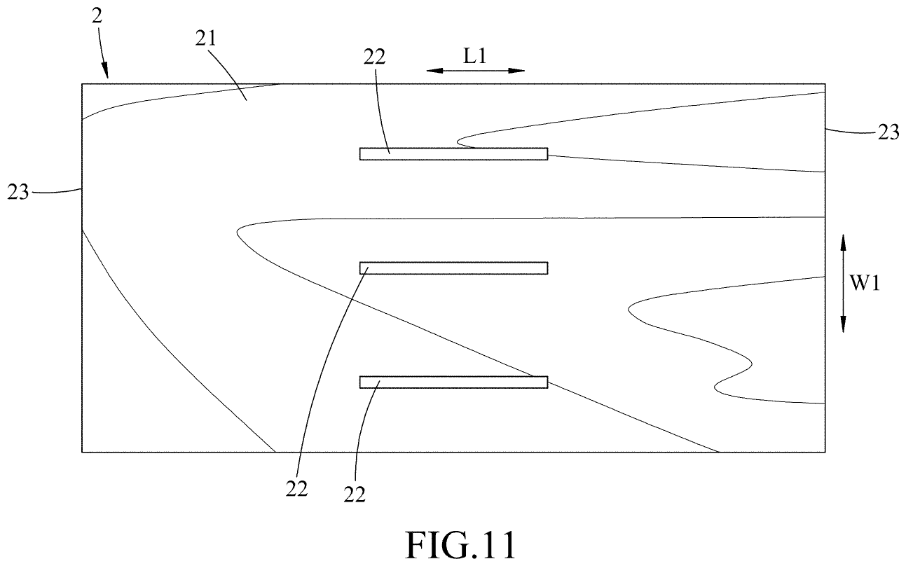

FIGS. 9 to 11 illustrate a crack-resistant composite wood construction according to a third embodiment of the disclosure. The third embodiment is similar to the first embodiment, except that, in the third embodiment, the first wooden body 1 includes three of the first crack-resistant grooves 12 and the second wooden body 2 includes three of the second crack-resistant grooves 22. Each of the first crack-resistant grooves 12 extends in the first wood grain direction (L1) without reaching either of the first marginal ends 13. Each of the second crack-resistant grooves 22 extends in the second wood grain direction (L2) without reaching either of the second marginal ends 23.

The third embodiment may also achieve the effects achieved in the first embodiment. In this embodiment, when viewing the crack-resistant composite wood construction from lateral sides (see FIG. 9), the first and second crack-resistant grooves 12, 22 are not observed, and the crack-resistant composite wood construction may have a better appearance.

In sum, with the provision of the first and second crack-resistant grooves respectively in the first and second wooden bodies, the first and second wooden bodies are less likely to have stress accumulated therein, and thus are less likely to deform or to crack. Hence, the crack-resistant composite wood construction may be more durable than a conventional one.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A crack-resistant composite wood construction comprising:
a first wooden body having a natural wood grain in a first wood grain direction, and including a first juncture surface, and at least a first crack-resistant groove which is formed in said first juncture surface and which is elongated in the first wood grain direction; and
a second wooden body having a natural wood grain in a second wood grain direction, and including a second juncture surface which is adhered to said first juncture surface, and at least a second crack-resistant groove which is formed in said second juncture surface and which is elongated in the second wood grain direction.

2. The crack-resistant composite wood construction according to claim 1, wherein said first wooden body includes a pair of first marginal ends which are opposite to each other in the first wood grain direction, said first crack-resistant groove extending in the first wood grain direction from one of said first marginal ends to the other one of said first marginal ends.

3. The crack-resistant composite wood construction according to claim 1, wherein said second wooden body includes a pair of second marginal ends which are opposite to each other in the second wood grain direction, said second crack-resistant groove extending in the second wood grain direction from one of said second marginal ends to the other one of said second marginal ends.

4. The crack-resistant composite wood construction according to claim 1, wherein said first wooden body includes a pair of first marginal ends which are opposite to each other in the first wood grain direction, said first crack-resistant groove extending in the first wood grain direction from one of said first marginal ends without reaching the other one of said first marginal ends.

5. The crack-resistant composite wood construction according to claim 1, wherein said second wooden body includes a pair of second marginal ends which are opposite to each other in the second wood grain direction, said second crack-resistant groove extending in the second wood grain direction from one of said second marginal ends without reaching the other one of said second marginal ends.

6. The crack-resistant composite wood construction according to claim 1, wherein the first and second wood grain directions are substantially the same.

7. The crack-resistant composite wood construction according to claim 6, wherein said first and second crack-resistant grooves are in register with each other.

8. The crack-resistant composite wood construction according to claim 6, wherein said first and second crack-resistant grooves are staggered from each other.

9. The crack-resistant composite wood construction according to claim 6, wherein said first wooden body includes a plurality of said first crack-resistant grooves which are spaced apart from each other and evenly distributed in said first juncture surface, said second wooden body including a plurality of said second crack-resistant grooves which are spaced apart from each other and evenly distributed in said second juncture surface.
